(19) United States
(12) Patent Application Publication
(10) Pub. No.: US 2010/0188863 A1
(43) Pub. Date: Jul. 29, 2010

(54) HOLDER FOR REMOVABLY ATTACHING A TOOL TO AN OBJECT AND METHOD THEREOF

(75) Inventor: Scott Andrew West, Boondal (AU)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: FERNO-WASHINGTON, INC., Wilmington, OH (US)

(21) Appl. No.: 12/377,194

(22) PCT Filed: Jul. 30, 2007
(86) PCT No.: PCT/US07/74686

§ 371 Date: Apr. 16, 2010

Related U.S. Application Data
(60) Provisional application No. 60/837,026, filed on Aug. 11, 2006.

(51) Int. Cl. F21V 19/02; B23P 11/00; B60R 9/00

(52) U.S. Cl. 362/418; 29/525.01; 224/401

(57) ABSTRACT

A holder (10) for removably mounting and positioning a tool (12) such as a flashlight (16) to an object (14), such as an emergency cot, and method thereof are disclosed. The holder comprises a base (20) and an elastic retaining strap (22) to facilitate a quick mounting to the object. The holder further includes elastic retainers (56, 58) to facilitate hands-free positioning of the tool in any desired direction.

This invention relates generally to devices for holding a tool to an object and, more particularly, it relates to a holder for removably attaching a tool, such as a flashlight, to an object, such as an emergency cot, and method thereof.

There is often a need or desire to direct light on an object or area without the use of hands in order to perform a task safely and correctly. In order to free both hands, the flashlight user has resorted to a number of different attempts to properly hold the flashlight. These attempts have included propping the flashlight on some support, holding it under the user's arm, head or between his legs, or in many instances holding the flashlight in his mouth. These attempts to hold the flashlight are generally awkward, restrict the movement of the user, and do not support the flashlight in a stable manner. As a result, the flashlight is frequently dropped, sometimes damaging the flashlight and/or placing the flashlight user in a precarious position.

It is against the above background that the present invention provides a holder for removably mounting and positioning a tool such as a flashlight to an object, such as an emergency cot, and method thereof. The holder comprises a base and elastic retaining strap to facilitate a quick mounting to the object. The holder further includes cording to facilitate hands-free positioning of the tool in any desired direction.

In one embodiment, a holder for removably attaching a tool to an object is disclosed. The holder comprises a base member, and a first quick-release mechanism to facilitate quick-release of the holder from the object. The first quick-release mechanism provides a first frictional interface between the base member and the object, wherein the first frictional interface can be manually overcome so that relative rotational position of the base member to the object can be manually adjusted. The holder also comprises a second quick-release mechanism to facilitate quick-release of the tool from the holder independent from the first quick-release mechanism. The second quick-release mechanism provides a second frictional interface between the base member and the tool, wherein the second frictional interface can be manually overcome so that orientation of the tool relative to the base member can be manually adjusted.

In another embodiment, a holder for removably attaching a tool to an object comprises a base member, and a first quick-release mechanism comprising an elastic member and bollards. The first quick release mechanism facilitates quick-release of the holder from the object and provides a first frictional interface between the base member and the object, wherein the first frictional interface can be manually overcome so that relative rotational position of the base member to the object can be manually adjusted without removing an engagement between the elastic member with the bollards. The holder also comprises a second quick-release mechanism comprising a pair of elastic retainers. The second quick-release mechanism facilitates quick-release of the tool from the holder independent from the first quick-release mechanism, and provides a second frictional interface between the base member and the tool, wherein the second frictional interface can be manually overcome so that orientation of the tool relative to the base member can be manually adjusted.

In still another embodiment, a method of securing a tool to an object is disclosed. The method comprises providing a holder having a base member, an elastic retaining strap, bollards, and elastic retainers, and releasably attaching the base member to the object via wrapping the elastic retaining strap around a portion of the object and releasably attaching the elastic retaining strap to the bollards. The elastic retaining strap places the bollards under elastic tension when attached thereto and providing a first frictional interface between the object and the base member, wherein the first frictional interface can be manually overcome so that relative rotational position of the base member to the object can be manually adjusted without removing the elastic tension from the bollards. The method further comprises releasably holding the tool with the elastic retainers. The elastic retainers provide a second frictional interface between the base member and the tool, wherein the second frictional interface can be manually overcome so that orientation of the tool relative to the base member can be manually adjusted.

Other advantages of the system of the present invention will be apparent from the following detailed description. The invention is described in more detail hereinafter with reference to the accompanying drawings.

The present invention is illustrated by way of example and not limitation in the accompanying figures, in which like references indicate similar elements, and in which:

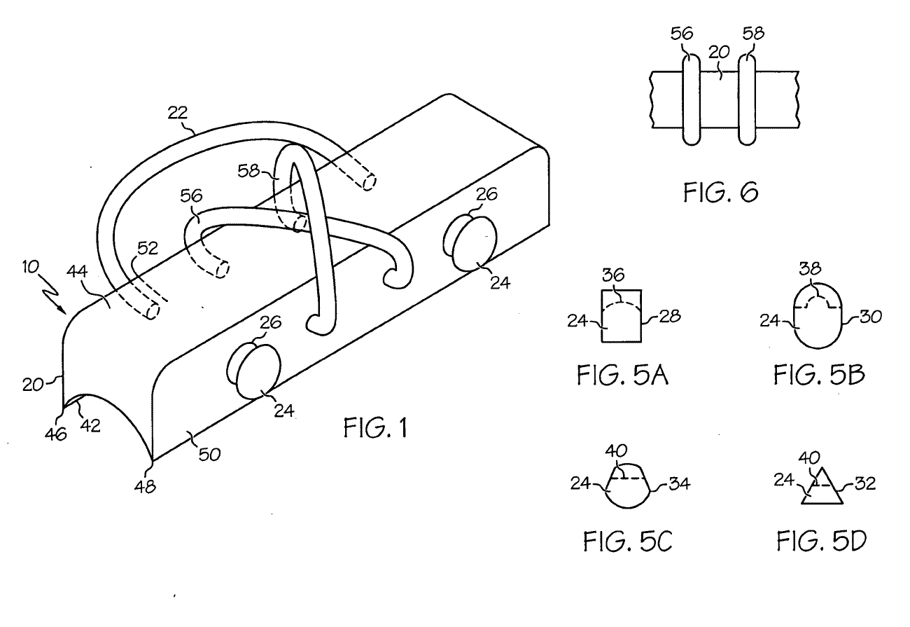

FIG. 1 is a front, side perspective view of a holder constructed in accordance with the present invention;

FIG. 2 is a front, side perspective view of the holder illustrated in FIG. 1 releasably attached to an object in accordance with the present invention;

FIG. 3 is a front, side perspective view of the holder illustrated in FIG. 2 releasably attached to an object and releasably holding a flashlight in accordance with the present invention; and

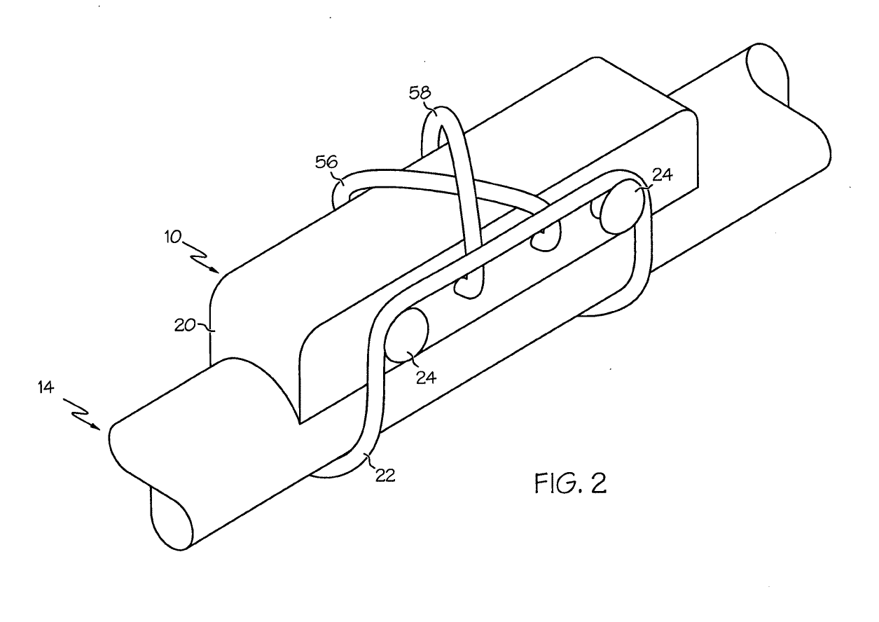

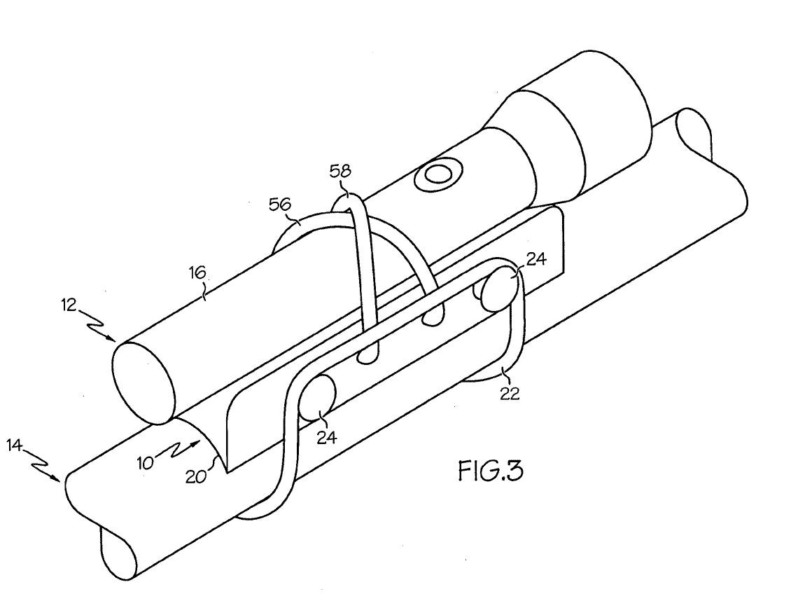

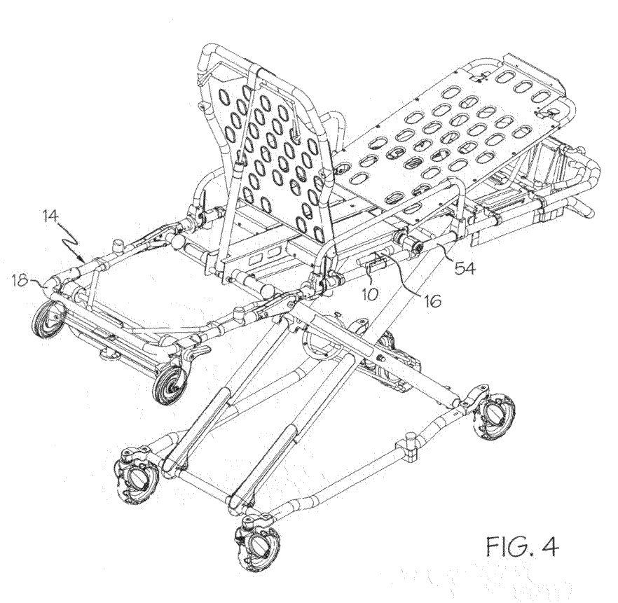

FIG. 4 is a side elevational view of the holder illustrated in FIG. 3 releasably attached to an ambulance cot in accordance with the present invention.

FIG. 5 is a top view of alternative holder embodiments having various bollard designs in accordance with the present invention; and

FIG. 6 is a top view of an alternative holder embodiment, partially shown, having a pair of retainers in a parallel pattern in accordance with the present invention.

Referring to FIGS. 1-6 the present invention relates to a holder 10 for removably holding a tool, generally indicated by symbol 12, to an object, generally indicated by symbol 14. In one embodiment, the tool 12 is a flashlight 16, and the object 14 is an emergency cot 18. In other embodiments, the tool 12 may be any conventional object that can be held releasably by the holder 10, and the object 14 may be any object to which the holder may releasably attach thereto as described herein. In the illustrated embodiment of FIGS. 3 and 4, the flashlight 16 is of a tubular construction containing either “AA” or “AAA” batteries, and having a light source at one end. The flashlight 16 is conventional and is included only to show releasable attachment to holder 10 and its operation thereof.

Referring to FIG. 1, holder 10 includes a base member 20, an elastic member or retaining strap 22, and bollards 24. As shown by FIG. 2, the retaining strap 22 with the bollards 24 serves to releasably attach the base member 20 to the object 14. The retaining strap 22 wraps around a portion of the object 14 and is retained releasably in place by the bollards 24 under elastic tension. In one embodiment, the bollards 24 are circular and in other embodiments, the bollards may be any other shape which can releasably retains the elastic retaining strap 22. As illustrated by FIG. 5, such shapes of the bollards 24 may include, and not to be limited to, rectangle 28, oval 30, triangle 32, and freeform 34. In one embodiment, each of the bollards 24 has a shaped surface 26. In one embodiment, the shaped surface 26 is a curved surface, such as concave, and in other embodiments may by an indentation 36, a partially curved surface 38, or flat surface 40. In one embodiment, the shaped surface 26 goes around the entire side(s) of bollard, and in other embodiments, the shaped surface 26 may only be provided around a portion thereof.

The base member 20 serves to removably mount the holder 10 on some convenient object 14 to support both the holder 10 and the flashlight 16, as shown in FIG. 3. When the retaining strap 22 is situated around the object 14 and the bollards 24 as depicted by FIG. 2, because the retaining strap 22 is maintained under elastic tension, a frictional engagement/interface will be maintained between the object 14 and the base member 20, and between the object 14 and the contacting portion of the retaining strap 22. This frictional interface is such that the relative rotational position of the base member 20 to the object 14 will be maintained; yet, the frictional interface can be manually overridden to manually vary the relative rotational position of the base member 20 to the object 14 without releasing the retaining strap 22 from the bollards 24.

The base member 20 is formed from an elongate piece of material and provides a curved surface 42 on a first side and on an opposed side, a relatively flat surface 44 as best shown by FIG. 1. On a side 50 adjacent the curved surface 42, the bollards 24 are provided and on the side 52 opposite the bollards, the elastic retaining strap 22 is attached to the base member 20. The curved surface 42 will mate closely with an opposing curved surface of the object 14, and edges thereof will act as legs 46 and 48 to support the holder 10 to a flat surface of the object 14. The base member 20 in one embodiment is a molded polymer, such as for example and not to be limited to, a high impact resistant plastic material. The base member 20 provides the curved surface 42 having a radius of curvature which is consistent with the shape of a tubular side frame member 54 of the cot 18. In other embodiment, the base member may be formed by working such as for example, cutting, shaping, and drilling any suitable material, such as for example, and not to be limited to, wood, metals, alloys, fibrous materials, composites, into the desired shape.

To releasably hold a tool 12, the holder 10 is provided with a pair of elastic members or retainers 56 and 58. As shown by FIG. 1, first ends of the retainers 56 and 58 are attached to the same side as the bollards 24, and second ends thereof are attached to same side at the retaining strap 22. Accordingly, the retainers 56 and 58 span over the flat surface 44.

In the illustrated embodiment, the pair of elastic retainers 56 and 58 are provide in a crisscross pattern, and in other embodiments may be provided in a parallel pattern as shown by FIG. 6. The pair of elastic retainers 56 and 58 is sized such that a tool 12, such as a flashlight 16, may be slipped under the retainers 56 and 58, and stretching them there around. When one or both of the elastic retainers 56 and 58 are situated around the tool 12, such as flashlight 16 as depicted by FIG. 3, because the elastic retainers 56 and 58 are under elastic tension, a frictional engagement/interface will be maintained between the tool 12 and the base member 20, and between the tool 12 and the contacting portions of the elastic retainers 56 and 58. This frictional interface is such that the relative orientation/rotational position of the tool 12 to the base member 20 will be maintained; yet, the frictional interface can be manually overridden to manually vary the relative orientation/rotational position of the tool 12 to the base member 20.

The characteristics of the both the elastic retaining strap 22, and elastic retainers 56 and 58 have an effect on the operation of the holder 10 since it is the bias force of these elastic members 22, 56, and 58 on the base member 20 which controls the frictional interfaces between the holder 10 and the object 14 and tool 12, respectively. For example, the frictional interface between the holder 10 and tool 12 should be great enough that the weight of the tool 12, such as flashlight 16, is not sufficient to rotate the tool 12; however, it is not so great as to prevent the user from manually overcoming the effect of the frictional interface so that the user can manually adjust the orientation of the tool.

In addition, the frictional interface between the holder 10 and the object 14 should be great enough that the weight of the tool 12, such as flashlight 16, is not sufficient to rotate base member 20 about the object 14; however, it is not so great as to prevent the user from manually overcoming the effect of the frictional interface so that the user can manually adjust relative rotational position of the base member 20 without having to release the retaining strap 22 from the bollards 24. While a wide variety of elastic members for elastic retaining strap 22 and elastic retainers 56 and 58 may be used, in one embodiment a shock cord having a diameter ranging from ⅛^{th} of an inch to ¼^{th} of an inch has been found satisfactory. In other embodiments, the elastic members 22, 56 and 58 may be rubber tubing, rubber bands, springs, and combinations thereof

In view the above, it is to be appreciated that the holder 10 according to the present invention provides a first quick-release mechanism, in the form of the elastic retaining strap 22 and bollards 24, to facilitate quick-release of the holder 10 from the object 14. Further, it is to be appreciated that holder 10 comprising a second quick-release mechanism in the form of the retainers 56 and 58, to facilitate quick-release of the tool 12 from the holder 10 independent from the first quick-release mechanism. It is to be appreciated further that the second quick-release mechanism also facilities in the embodiment when the tool 12 is a flashlight, both hands-free flashlight operation and quick-release use of the flashlight.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

1. A holder for removably attaching a tool to an object, said holder comprising:
a base member;
a first quick-release mechanism to facilitate quick-release of the holder from the object, said first quick-release mechanism providing a first frictional interface between said base member and the object, wherein said first frictional interface can be manually overcome so that relative rotational position of said base member to the object can be manually adjusted; and
a second quick-release mechanism to facilitate quick-release of the tool from said holder independent from said first quick-release mechanism, said second quick-release mechanism providing a second frictional interface between said base member and the tool, wherein said second frictional interface can be manually overcome so that orientation of the tool relative to said base member can be manually adjusted.

2. The holder according to claim 1, wherein said first quick-release mechanism comprises an elastic member and at least one bollard.

3. The holder according to claim 1, wherein said second quick-release mechanism comprises at least one elastic member.

4. The holder according to claim 1, wherein said tool is a flashlight.

5. The holder according to claim 1, wherein said object is an emergency cot.

6. The holder according to claim 1, wherein said first quick-release mechanism comprises an elastic member and a pair of bollards having a circular surface.

7. The holder according to claim 1, wherein said first quick-release mechanism comprises an elastic member and a pair of bollards, said bollards being a shape selected from rectangle, oval, circular, and triangle.

8. The holder according to claim 1, wherein said first quick-release mechanism comprises an elastic member and a pair of bollards, each of said bollards has a shaped surface selected from a curved surface, an indentation, a partially curved surface, and a flat surface.

9. The holder according to claim 1, wherein said base member comprises an elongate piece of material and provides a curved surface on a first side and a relatively flat surface on a side opposed to said first side.

10. The holder according to claim 1, wherein said first quick-release mechanism comprises an elastic member and a pair of bollards, and wherein said base member provides a curved surface on a first side, said bollards being provided on a second side adjacent said first side, and said elastic member being provided on a third side adjacent said first side.

11. The holder according to claim 1, wherein said base member is molded material and provides a curved surface having a radius of curvature which is consistent with a radius of curvature of the object.

12. The holder according to claim 1, wherein said base member is a material selected from polymers, wood, metals, alloys, fibrous materials, and composites.

13. The holder according to claim 1, wherein said a second quick-release mechanism is the pair of elastic retainers.

14. The holder according to claim 1, wherein said a second quick-release mechanism is the pair of elastic retainers provided in a crisscross pattern.

15. The holder according to claim 1, wherein said a second quick-release mechanism is the pair of elastic retainers provided in a parallel pattern.

16. The holder according to claim 1, wherein said a second quick-release mechanism is the pair of elastic retainers each having a diameter ranging from ⅛th of an inch to ¼th of an inch.

17. The holder according to claim 1, wherein said first and second quick-release mechanism are a material selected from shock cord, rubber tubing, rubber bands, springs, and combinations thereof.

18. The holder according to claim 1, wherein said first quick-release mechanism comprises an elastic member and a pair of bollards, and wherein said base member provides a curved surface on a first side, said bollards being provided on a second side adjacent said first side, said elastic member being provided on a third side adjacent said first side, and said second quick-release mechanism is a pair of elastic retainers having first ends attached to said second side and second ends attached to said third side.

19. A holder for removably attaching a tool to an object, said holder comprising:
a base member;
a first quick-release mechanism comprising an elastic member and bollards, said first quick release mechanism facilitates quick-release of the holder from the object and provides a first frictional interface between said base member and the object, wherein said first frictional interface can be manually overcome so that relative rotational position of said base member to the object can be manually adjusted without removing an engagement between said elastic member with said bollards; and
a second quick-release mechanism comprising a pair of elastic retainers, said second quick-release mechanism facilitates quick-release of the tool from said holder independent from said first quick-release mechanism, and provides a second frictional interface between said base member and the tool, wherein said second frictional interface can be manually overcome so that orientation of the tool relative to said base member can be manually adjusted.

20. A method of securing a tool to an object comprising:
providing a holder comprising a base member; an elastic retaining strap, bollards, and elastic retainers;
releasably attaching said base member to the object via wrapping said elastic retaining strap around a portion of the object and releasably attaching said elastic retaining strap to said bollards, said elastic retaining strap placing said bollards under elastic tension when attached thereto and providing a first frictional interface between the object and said base member, wherein said first frictional interface can be manually overcome so that relative rotational position of said base member to the object can be manually adjusted without removing said elastic tension from said bollards; and
releasably holding the tool with said elastic retainers, said elastic retainers providing a second frictional interface between said base member and the tool, wherein said second frictional interface can be manually overcome so that orientation of the tool relative to said base member can be manually adjusted.
